(19) United States
(12) Patent Application Publication
(10) Pub. No.: US 2017/0287177 A1
(43) Pub. Date: Oct. 5, 2017

(54) METHODS AND APPARATUSES FOR FORMATTING INTERFACE DATA

(71) Applicant: Change Healthcare LLC, Alpharetta, GA (US)

(72) Inventor: Eldon Wong, Vancouver (CA)

(73) Assignee: Change Healthcare LLC, Alpharetta, GA (US)

(21) Appl. No.: 15/086,176

(22) Filed: Mar. 31, 2016

(51) Int. Cl. G06T 11/20; G06F 3/0486

(52) U.S. Cl. CPC G06T 11/206; G06F 3/0486; G06T 2200/24

(57) ABSTRACT

A method, apparatus and computer program product provide a visualization interface. An example of the method includes receiving a first set of clinical data associated with one or more patients, formatting the first set of clinical data for inclusion in a data object, processing the data object to generate a set of derived data, generating a visualization interface comprising at least one component of the formatted data and the derived data, and causing output of the visualization interface.

### TECHNOLOGICAL FIELD

Example embodiments of the present invention relate generally to methods, systems, and computer readable storage media for formatting interface data and, more particularly, to methods, systems, and computer readable media for providing improved interfaces for displaying clinical data.

### BACKGROUND

As more and more healthcare organizations complete the move to electronic health records, clinicians are being provided with access to more clinical data than ever before. However, just because clinicians have access to this data does not mean that they are able to review and analyze it in an efficient manner. Typical systems for displaying electronic health records utilize complex charts and graphs that do not necessarily lend themselves to efficient analysis. This problem is exacerbated as more and more data is made available, such that practitioners have no easy way to visualize the reams of data that may be associated with a particular patient or patients over time, across multiple patient encounters, or across multiple different patients.

Furthermore, existing systems for visualizing clinical data are static. While this provides the benefit of the data being self-contained and consistent, the use of static displays limits the options clinicians have for visualization. Systems that enable viewing of medical records lack the ability to reformat data and provide side-by-side comparisons.

Through applied effort, ingenuity, and innovation, the inventors have solved many of these identified problems by developing a technical solution that is embodied by the present invention, which is described in detail below.

### BRIEF SUMMARY

Methods, apparatuses and computer program products are therefore provided according to example embodiments of the present invention in order to provide improved techniques for formatting and displaying received data. Embodiments provide an interface component that receives clinical data and formats the received data into a generic format. The received data is used to generate derived data, and the formatted data and derived data are used to identify a set of characteristics of the patient or patients. Embodiments also serve to identify particular interface components for particular components of the formatted data and derived data such that the clinician user is provided with an efficient, customizable, editable, and flexible display for visualizing and analyzing received clinical data.

An example of an embodiment of a method for implementing a computer visualization interface includes receiving a first set of clinical data associated with one or more patients, formatting the first set of clinical data for inclusion in a data object, processing the data object to generate a set of derived data, generating a visualization interface comprising at least one component of the formatted data and the derived data, and causing output of the visualization interface.

In some embodiments, the visualization interface further comprises a first interface control. The first interface control may comprise an anatomical approximation of a human body and one or more sub-interface controls associated with one or more clinical statuses derived from the first set of clinical data, such that selection of the one or more sub-interface controls displays additional information related to the one or more clinical statuses. The visualization interface may include a second interface control for displaying demographic data derived from the first set of clinical data, wherein selection of the sub-interface control causes an interface effect to be applied to at least one element of the demographic data associated with the one or more clinical statuses associated with the sub-interface control. The method may include receiving a second set of clinical data associated with the one or more patients, formatting the second set of clinical data for inclusion in the data object, and adding the formatted second set of clinical data to the data object. In some embodiments, the method may include receiving a second set of clinical data associated with the one or more patients, updating the visualization interface to comprise at least one of a component of the second set of clinical data or data derived from the second set of clinical data, and applying a first interface effect to a first element of the visualization interface derived from the first set of clinical data, and a second interface effect to a second element of the visualization interface derived from the second set of clinical data, wherein the first interface effect is different from the second interface effect and wherein the first interface effect is selected based on the first element being associated with the first set of clinical data and the second element being associated with the second set of clinical data.

The method may include receiving, at the visualization interface via a drag and drop operation, at least one clinical data record dragged from an electronic health record interface, wherein the drag and drop operation causes the at least one clinical data record to be provided as the first set of clinical data. Processing the data object to generate the derived data may include applying a set of derivation rules, the set of derivation rules comprising one or more conditional statements to be applied to the clinical data to generate the derived data. The visualization interface may include a data entry control, and the method may include receiving entered clinical data via the data entry control, updating at least one of the formatted data or the derived data to reflect the entered clinical data, and updating the visualization interface to reflect the updated at least one of the formatted data or the derived data.

An example of an embodiment also includes an apparatus for implementing a computer visualization interface. The apparatus includes a processor and a memory. The memory stores instructions executed by the processor to configure the processor to receive a first set of clinical data associated with one or more patients, format the first set of clinical data for inclusion in a data object, process the data object to generate a set of derived data, generate a visualization interface comprising at least one component of the formatted data and the derived data, and cause output of the visualization interface.

In some embodiments, the visualization interface further comprises a first interface control and the first interface control comprises an anatomical approximation of a human body and one or more sub-interface controls associated with one or more clinical statuses derived from the first set of clinical data, such that selection of the one or more sub-interface controls displays additional information related to the one or more clinical statuses. The visualization interface may include a second interface control for displaying demographic data derived from the first set of clinical data, and selection of the sub-interface control may cause an interface effect to be applied to at least one element of the demographic data associated with the one or more clinical statuses associated with the sub-interface control. The apparatus may be further configured to receive a second set of clinical data associated with the one or more patients, format the second set of clinical data for inclusion in the data object, and add the formatted second set of clinical data to the data object. The apparatus may also be configured to receive a second set of clinical data associated with the one or more patients, update the visualization interface to comprise at least one of a component of the second set of clinical data or data derived from the second set of clinical data, and apply a first interface effect to a first element of the visualization interface derived from the first set of clinical data, and a second interface effect to a second element of the visualization interface derived from the second set of clinical data, wherein the first interface effect is different from the second interface effect and wherein the first interface effect is selected based on the first element being associated with the first set of clinical data and the second element being associated with the second set of clinical data. The apparatus may be further configured to receive, at the visualization interface via a drag and drop operation, at least one clinical data record dragged from an electronic health record interface, wherein the drag and drop operation causes the at least one clinical data record to be provided as the first set of clinical data. Processing the data object to generate the derived data may include applying a set of derivation rules. The set of derivation rules may include one or more conditional statements to be applied to the clinical data to generate the derived data. In some embodiments, the visualization interface includes a data entry control, and the apparatus is further configured to receive entered clinical data via the data entry control, update at least one of the formatted data or the derived data to reflect the entered clinical data, and update the visualization interface to reflect the updated at least one of the formatted data or the derived data.

Another example of an embodiment includes a non-transitory computer readable storage medium comprising instructions that, when executed by the processor, cause the processor to at least receive a first set of clinical data associated with one or more patients, format the first set of clinical data for inclusion in a data object, process the data object to generate a set of derived data, generate a visualization interface comprising at least one component of the formatted data and the derived data, and cause output of the visualization interface.

The visualization interface may include a first interface control. The first interface control may include an anatomical approximation of a human body and one or more sub-interface controls associated with one or more clinical statuses derived from the first set of clinical data, such that selection of the one or more sub-interface controls displays additional information related to the one or more clinical statuses. The visualization interface may include a second interface control for displaying demographic data derived from the first set of clinical data, wherein selection of the sub-interface control causes an interface effect to be applied to at least one element of the demographic data associated with the one or more clinical statuses associated with the sub-interface control. The visualization interface may include a data entry control, and the instructions further configure the processor to receive entered clinical data via the data entry control, update at least one of the formatted data or the derived data to reflect the entered clinical data, and update the visualization interface to reflect the updated at least one of the formatted data or the derived data.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of an apparatus for providing improved visualization interfaces in accordance with some embodiments of the present invention;

FIGS. 2A and 2B are illustrations of improved visualization interfaces in accordance with some embodiments of the present invention;

FIG. 3 is an illustration of a drag and drop operation for populating an improved visualization interface in accordance with some embodiments of the present invention;

FIG. 4 depicts a data flow among components of a system for providing an improved visualization interface in accordance with some embodiments of the present invention;

FIG. 5 depicts an illustration of a flow diagram illustrating an example of a method for providing an improved visualization interface in accordance with embodiments of the present invention; and

FIG. 6 depicts an illustration of a flow diagram illustrating an example of a method for populating components of an improved visualization interface in accordance with embodiments of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

### INTRODUCTION

A method, apparatus and computer program product are provided in accordance with example embodiments of the present invention to provide improved interfaces for visualizing data. As noted above, the inventors have identified that present systems for viewing and analyzing data, particularly clinical data, are inadequate. To address these problems and other problems, the inventors have developed a system that provides a flexible, efficient interface for receiving, formatting, categorizing and outputting clinical data. This interface is further operable to process received data to determine derived data which is also displayed via the interface. The interface is organized such that received data is routed to a particular portion of the interface based on the type of data. Embodiments may further provide an efficient mechanism for updating the content of data displayed via the interface to allow for visualization of the impact of changes in the data on analysis provided by the display.

For the purposes of this disclosure, the term “interface control” should be understood to refer to a portion of a visualization interface with which a user of the interface may separately view or interact. Interface controls may include both interactive controls (e.g., controls that may be selected to cause the interface to initiate some processing task), and static controls (e.g., display windows or areas that provide visual or other feedback to the user by which do not separately provide a mechanism for selection to initiate a processing task).

### Exemplary Client Apparatus

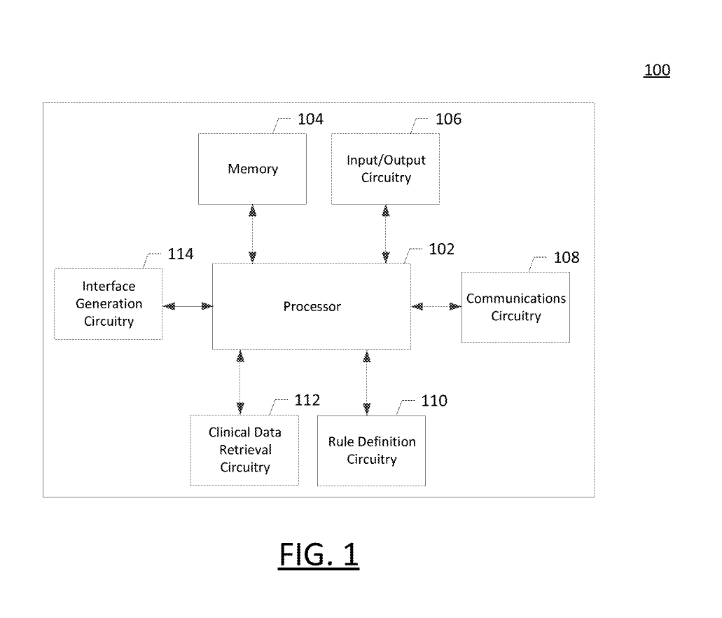

FIG. 1 illustrates a block diagram of an apparatus 100 in accordance with some example embodiments. The apparatus 100 may be any computing device capable of implementing an improved visualization interface as described herein. For example, the apparatus 100 may be implemented as a computing device executing one or more applications for providing and outputting the visualization interface. The apparatus 100 implements hardware and software that serves to receive data, format the data for display in an interface, and output the data in a straightforward, efficient manner for improved analysis.

The apparatus 100 may be implemented as a standalone or rack-mounted server, a desktop computer, a laptop computer, a personal digital assistant, a tablet computer, a netbook computer, a mobile device, or the like. Accordingly, it will be appreciated that the apparatus 100 may comprise devices, hardware, and the like configured to implement and/or otherwise support implementation of various example embodiments described herein.

It should be noted that the components, devices or elements illustrated in and described with respect to FIG. 1 below may not be mandatory and thus some may be omitted in certain embodiments. Additionally, some embodiments may include further or different components, devices or elements beyond those illustrated in and described with respect to FIG. 1.

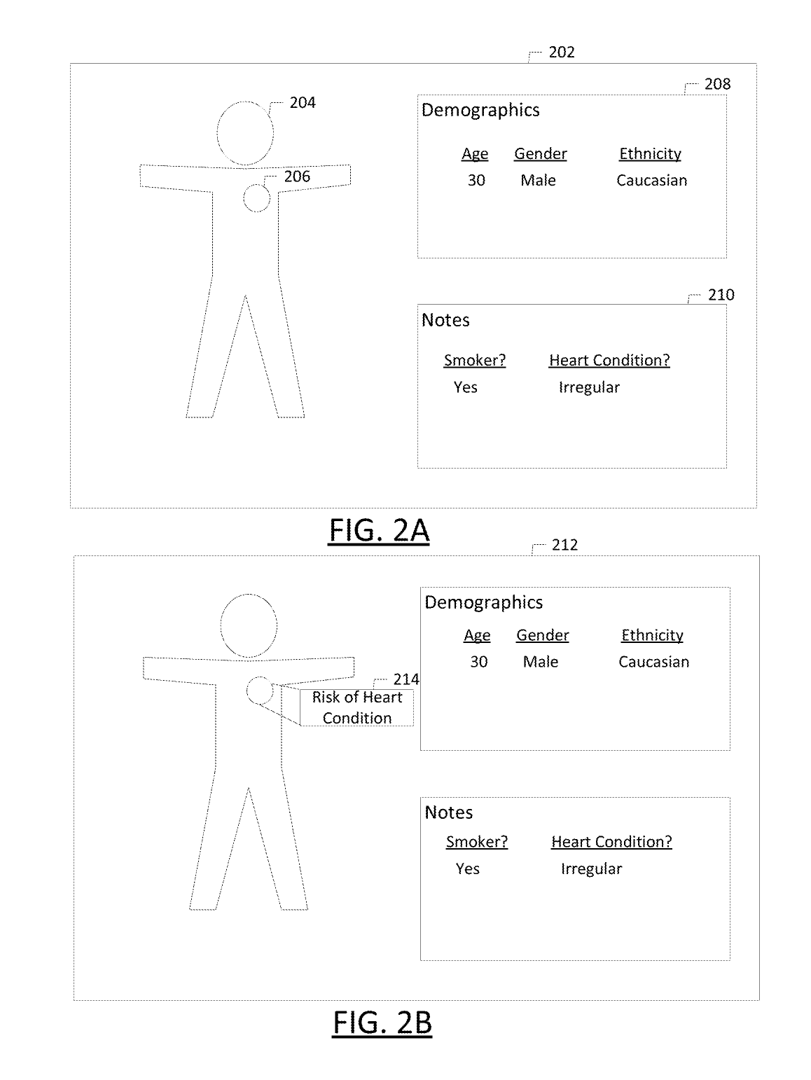

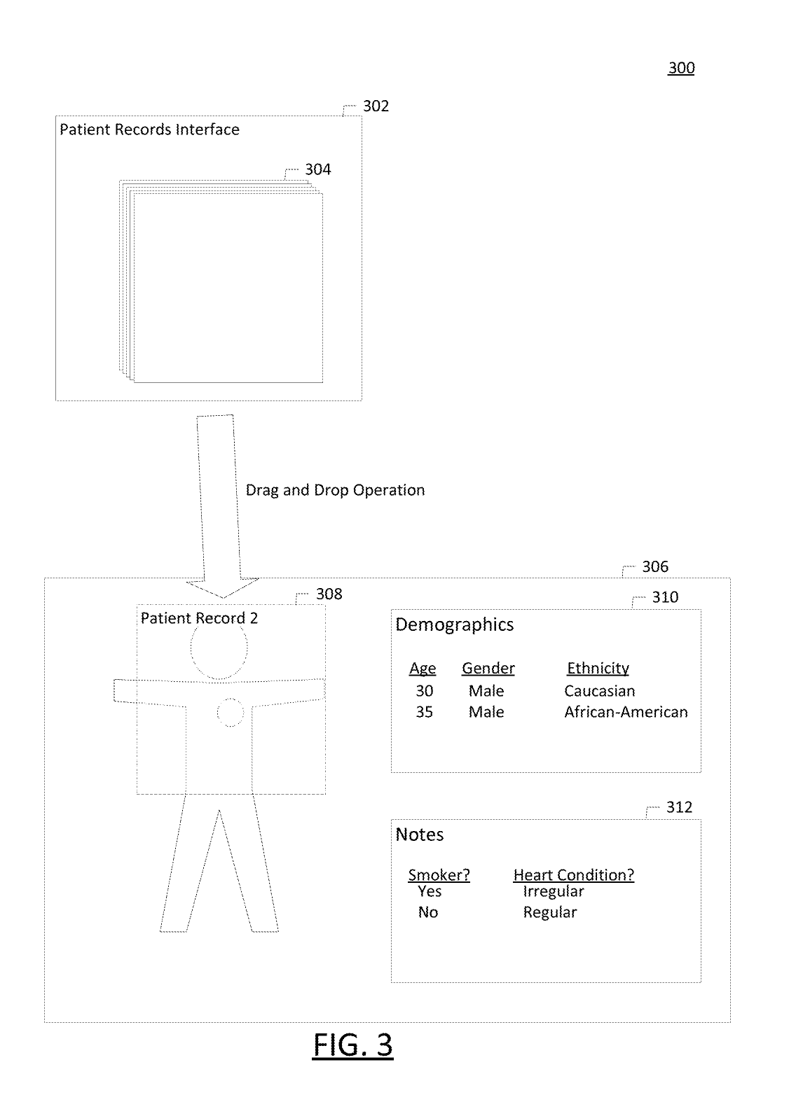

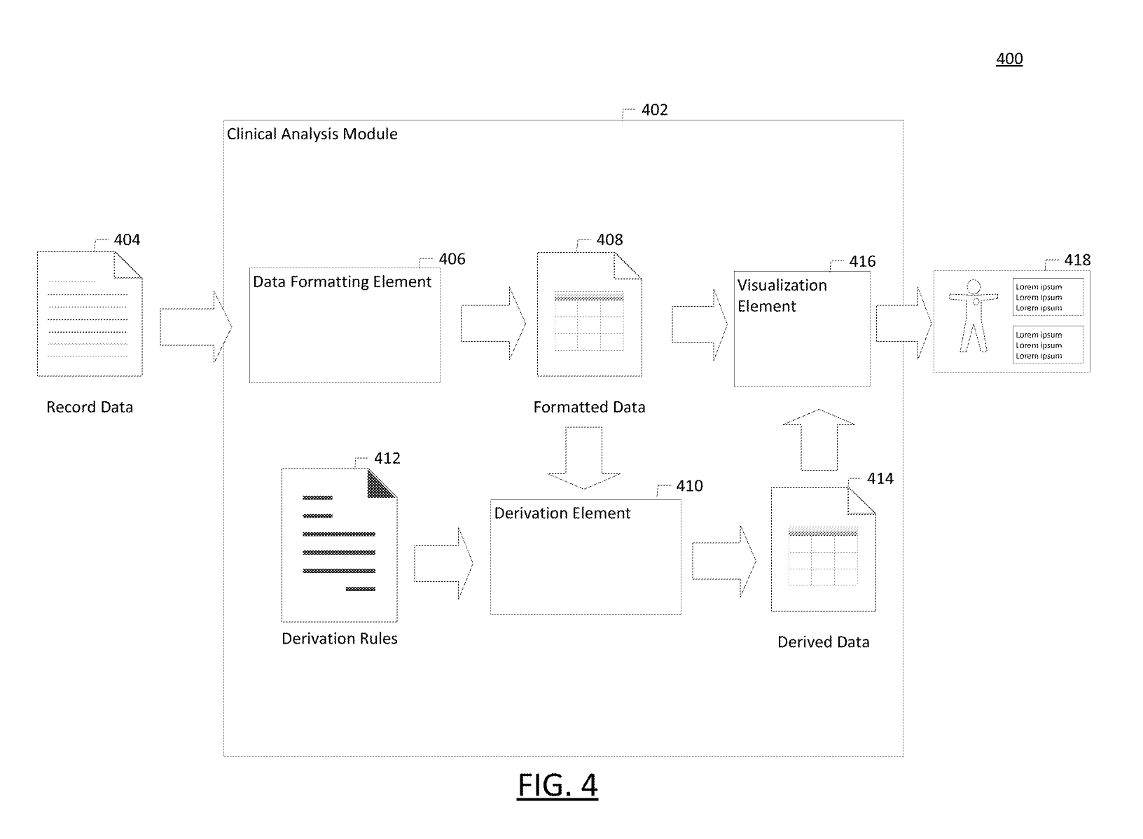

As illustrated in FIG. 1, an apparatus 100 may include a processor 102, a memory 104, input/output circuitry 106, communications circuitry 108, rule definition circuitry 110, clinical data retrieval circuitry 112, and interface generation circuitry 114. The apparatus 100 may be configured to display the interfaces described below with respect to FIGS. 2A-3 and to execute the operations described below with respect to FIGS. 4-6. Although these components 102-114 are described with respect to functional limitations, it should be understood that the particular implementations necessarily include the use of particular hardware. It should also be understood that certain of these components 102-114 may include similar or common hardware. For example, two sets of circuitry may both leverage use of the same processor, network interface, storage medium, or the like to perform their associated functions, such that duplicate hardware is not required for each set of circuitry. The use of the term “circuitry” as used herein with respect to components of the apparatus should therefore be understood to include particular hardware configured to perform the functions associated with the particular circuitry as described herein.

The term “circuitry” should be understood broadly to include hardware and, in some embodiments, software for configuring the hardware. For example, “circuitry” includes processing circuitry, storage media, network interfaces, input/output devices, and/or the like. In some embodiments, other elements of the apparatus 100 may provide or supplement the functionality of particular circuitry. For example, the processor 102 may provide processing functionality, the memory 104 may provide storage functionality, the communications circuitry 108 may provide network interface functionality, and the like, such that each of the circuitries may be formed by other circuitry components of the apparatus 100.

In some embodiments, the processor 102 (and/or co-processor or any other processing circuitry assisting or otherwise associated with the processor) may be in communication with the memory 104 via a bus for passing information among components of the apparatus. The memory 104 may be non-transitory and may include, for example, one or more volatile and/or non-volatile memories. In other words, for example, the memory may be an electronic storage device (e.g., a computer readable storage medium). The memory 104 may be configured to store information, data, content, applications, instructions, tables, data structures, or the like, for enabling the apparatus to carry out various functions in accordance with example embodiments of the present invention.

The processor 102 may include various processing devices and may, for example, include one or more processing devices configured to perform independently from one another. Additionally or alternatively, the processor may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In an example embodiment, the processor 102 may be configured to execute instructions stored in the memory 104 or otherwise accessible to the processor. Alternatively or additionally, the processor may be configured to execute hard-coded functionality. As such, whether configured by hardware or software methods, or by a combination thereof, the processor may represent an entity (e.g., physically embodied in circuitry) capable of performing operations according to an embodiment of the present invention while configured accordingly. Alternatively, as another example, when the processor is embodied as an executor of software instructions, and the instructions may specifically configure the processor to perform the algorithms and/or operations described herein when the instructions are executed.

In some embodiments, the apparatus 100 may include input/output circuitry 106 that may, in turn, be in communication with the processor 102 to provide output to the user and, in some embodiments, to receive an indication of a user input. The input/output circuitry 106 may comprise a user interface and may include a display and may comprise a web user interface, a mobile application, a client device, a kiosk, or the like. In some embodiments, the input/output circuitry 106 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 104, and/or the like). The input/output circuitry 106 may provide a mechanism for display of an improved visualization interface (e.g., via a monitor or other display), and receiving input related to that improved visualization interface (e.g., a mouse, keyboard, or the like).

The communications circuitry 108 may be any means such as a device or circuitry embodied in either hardware or a combination of hardware and software that is configured to receive and/or transmit data from/to a network and/or any other device, circuitry, or module in communication with the apparatus 100. In this regard, the communications circuitry 108 may include, for example, a network interface for enabling communications with a wired or wireless communication network. For example, the communications circuitry 108 may include one or more network interface cards, antennae, buses, switches, routers, modems, and supporting hardware and/or software, or any other device suitable for enabling communications via a network. Additionally or alternatively, the communication interface may include the circuitry for interacting with the antenna(s) to cause transmission of signals via the antenna(s) or to handle receipt of signals received via the antenna(s).

The rule definition circuitry 110 includes hardware configured to receive and/or generate and apply a set of conditional rules to a set of input data in order to generate derived data. For example, the rule definition circuitry 110 may provide a mechanism for text input to author one or more statements that include conditional variables (e.g., AND, OR, NOT, XOR, >, <, >=, <=, ==) to a set of input values stored within a set of formatted data. In the context of a dynamic clinical data visualization system, these rules may include conditional statements used to define various medical conditions from a set of input electronic health records data. Authoring these rules and applying the rules against a set of data may be performed by a processing element of the rule definition circuitry, such as the processor 102.

The clinical data retrieval circuitry 112 includes hardware configured to receive and process clinical data to format the clinical data in such a way that it can be utilized within a visualization interface as described herein. To this end, the clinical data retrieval circuitry 112 may include hardware configured to receive input data in a native format (e.g., in a format associated with a particular medical records application, data entry interface, or the like), and convert that input data into a source-agnostic format (e.g., JavaScript Object Notation (JSON) or the like). Formatting of the input data may also include classifying and/or categorizing the data into particular types (e.g., symptom data, demographic data, and the like) and otherwise identifying metadata for the received data (e.g., the identity of a patient or encounter associated with the data, assigning an index to the received data based on the order in which the data was received, or the like)

In some embodiments, the clinical data retrieval circuitry 112 may allow input of the clinical data via the visualization interface. For example, the visualization interface may allow user input to alter or input clinical data using the input/output circuitry 106, or the visualization interface may support the dragging and dropping of patient data onto components of the interface (e.g., by dragging a patient record from an electronic health record system and dropping the record on the visualization interface). To support these and other functions, the clinical data retrieval circuitry 112 includes a processing element, such as the processor 102.

The interface generation circuitry 114 includes hardware configured to generate an improved visualization interface used by the apparatus 100. The interface generation circuitry 114 may generate this interface based on a set of clinical data received by the clinical data retrieval circuitry 112. Examples of interfaces generated by the interface generation circuitry are described further below with respect to FIGS. 2A, 2B, and 3. To generate the interface, the interface generation circuitry 114 may apportion the set of clinical data into a plurality of interface controls to aid with the visualization and analysis process. The interface generation circuitry 114 may include a processing element, such as the processor 102 to facilitate generation of the interface.

As will be appreciated, any computer program instructions and/or other type of code may be loaded onto a computer, processor or other programmable apparatus's circuitry to produce a machine, such that the computer, processor other programmable circuitry that execute the code on the machine create the means for implementing various functions, including those described herein.

As described above and as will be appreciated based on this disclosure, embodiments of the present invention may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

Having now described an apparatus configured to implement and/or support implementation of various example embodiments, features of several example embodiments will now be described. It will be appreciated that the following features are non-limiting examples of features provided by some example embodiments. Further, it will be appreciated that embodiments are contemplated within the scope of disclosure that implement various subsets or combinations of the features further described herein. Accordingly, it will be appreciated that some example embodiments may omit one or more of the following features and/or implement variations of one or more of the following features.

### Exemplary Illustrations of Improved Visualization Interfaces

FIGS. 2A, 2B, and 3 illustrate examples of improved visualization interfaces in accordance with some embodiments of the present invention. It should be understood that these illustrations merely provide possible implementations of improved visualization interfaces, and that the particular interface controls depicted, their arrangement within the screen, the content and manner in which those interface controls are constructed and populated with data are not intended to be limiting.

FIG. 2A, for example, depicts a first example of an improved visualization interface 202. The interface 202 includes an interface control that depicts an anatomical approximation of a human body 204. The anatomical approximation 204 includes one or more controls 206 placed about the anatomical approximation 204. The relative positioning of the controls 206 with respect to the anatomical approximation 204 may correspond to particular portions of a patient's anatomy that are identified as being relevant to received or derived data. For example, if the patient has a heart condition or any clinical data that would indicate the status of the patient's heart, then a corresponding control 206 may be placed on the anatomical approximation 204 at a point corresponding to the heart of the anatomical approximation 204. Similarly, information related to the patient's brain might be used to place a control on the anatomical approximation's 204 head, and the like. It should be appreciated that a given interface control, such as the anatomical approximation 204 may also include one or more sub-controls such as the control 206.

A second interface control 208 may provide a display area of the interface in which patient demographic data (e.g., age, sex, ethnicity, etc.) is displayed. A third interface control 210 may provide a display area of the interface in which additional notes or derived data are displayed.

The visualization interface 202 may dynamically determine which elements of a set of received data to display using a particular interface control. For example, some relevant data may be displayed via the anatomical approximation 204, some relevant data may be displayed via the second interface control 208, and some relevant data may be displayed via the third interface control 210. The particular interface control used to display the data may be selected based on a variety of factors, such as the type of data as stored in a patient electronic health record.

In some embodiments, the anatomical approximation 204 may be used to display a plurality of controls 206 associated with different conditions, diagnoses, or other statuses of the patient. Selection of such a control 206 may also result in alteration of other portions of the visualization interface 202. For example, if a set of patient data appears to indicate a problem with the patient's heart, a control 206 may be placed over the patient's heart. Selection of that control may also cause the second interface control 208 and the third interface control 210 to be populated with relevant patient data associated with a diagnosis of a heart condition. Similarly, other controls may be applied to the anatomical approximation 204 for other identified conditions, and selection of those controls may cause highlighting or population of other interface controls to indicate related data fields in support of a diagnosis of the condition corresponding to the selected control.

FIG. 2B illustrates another example of a visualization interface 212. The visualization interface 212 depicts the result of a selection of the control 206 as described above with respect to FIG. 2A. Upon selection of the control (e.g., via a mouse click, touch screen input, or other action performed with respect to the control), a popup is generated to provide a visualization of one or more conditions corresponding to the control. It should be appreciated that while a single control is depicted in FIG. 2B, selection of such a control could also alternatively invoke display of a plurality of conditions, such as in a case where the visualization interface is depicting data associated with a plurality of patients, a plurality of patient encounters, a plurality of patient scenarios, or the like. Additional embodiments configured for display of scenarios applying multiple sets of data to the same visualization interface are described further below with respect to FIG. 3.

FIG. 3 illustrates one possible mechanism 300 for adding additional data to a visualization interface 306. As depicted, some embodiments may provide “drag and drop” functionality whereby a record or records may be dragged from a first interface (e.g., an electronic health records access system), and dropped directly on top of the visualization interface or a particular component thereof. For example, a patient records interface 302 may include a graphical display indicating the presence of a set of patient records. To load one or more of those records within the visualization interface 306, the user may execute a drag and drop of the record or records within the electronic health records interface, and drop those records into the visualization interface 306.

Upon dropping of a health record into the visualization interface 306, the data of the record may be converted into a generic format, used to derive any derived data, and subsequently the visualization interface may be updated to reflect the new data. For example, a patient record 308 is loaded by dragging and dropping the patient record 308 from the patient records interface 302 to the visualization interface 306. Performing this drag and drop operation may cause the patient records interface 302 to transmit data corresponding to the patient record 308 to the visualization interface 306, such as by enabling direct communication between the interfaces. Alternatively, the actual dragged patient record 308 may be associated with a data object (e.g., a JSON object) that the visualization interface 306 is operable to “open” upon having that object dropped on the interface. To this end, embodiments may utilize certain operating system functions, systems, and frameworks related to data transfer to effect such operations related to selecting and transferring data through the use of such graphical user interface objects.

Upon loading, additional lines of data are added to their respective interface controls to reflect the newly added data. For example, the demographics user interface control 310 is updated to add data for the second patient (e.g., African-American male, age 35), and the derived data user interface control 312 is updated to add that the second patient is not a smoker based on information derived from the dragged and dropped record 308. The interface 306 is therefore configured to simultaneously display multiple sets of patient data.

In some embodiments, patient data associated with a same record may have a same color scheme or other interface effect applied, such as color coding, highlighting, or the like. For example, data associated with a first patient encounter may receive a blue highlight, and data associated with a second patient encounter may receive a red highlight. In some embodiments, these interface effects are further consistent with interface effects associated with external applications, such as the patient records interface 302. For example, each record available for dragging and dropping from within the patient records interface 302 may have the same or similar interface effects applied as those records are displayed within the visualization interface 306. This may be accomplished by including information relating to the interface effect within data corresponding to the dragged and dropped record, or the patient records interface 302 may communicate with the visualization interface 306 to coordinate the interface effects across applications.

The instant exemplary interface 300 as depicted in FIG. 3 shows a mechanism for adding a data set to the visualization interface 306 via a drag and drop operation. However, it should be appreciated that various other mechanisms for adding or editing data sets may be employed. For example, the visualization interface 306 may provide a “File->Open” menu that allows selection of data sets from a file.

As another example, the visualization interface 306 may provide interface controls allowing for the selection and editing of a loaded data set to create additional data sets. In such a case, a first data set may be opened and used to populate an editing window. The user may utilize the editing window to adjust one or more characteristics of the data (e.g., changing a patient age from 30 to 75, or adding 20 pounds to the patient's weight) to generate a new data set for visualization. Such an interface may include interface controls for selecting particular data fields, naming the alternative data set, selecting an interface effect for the alternative data set, saving the alternative data set, and the like.

### Examples of Visualization Interface Data Flow

FIG. 4 illustrates a data flow 400 describing exemplary system interactions for providing improved visualization interfaces in accordance with embodiments of the present invention. The data flow 400 illustrates interactions among system components to support interactions among elements of a clinical analysis module 402 to produce a visualization interface as described herein.

The clinical analysis module 402 receives a set of record data 404 as input. As described above, the set of input record data may be received from an electronic health records application, via manual entry into the clinical analysis module (e.g., through the use of one or more data fields for entry or editing of data), or from any other internal or external source of clinical data (e.g., medical devices, imaging systems, scales, thermometers, blood pressure monitors, etc.).

The record data 404 is received by a data formatting element 406. The data formatting element 406 formats the record data 406 into a set of formatted data 408. Formatting of the record data 404 involves storing the data in a format suitable for use by the clinical analysis module 402 in creating a visualization interface. This process may include converting the record data 404 from a source-specific format into a single format (e.g., JSON or another object type) used by the clinical analysis module to store data received from different sources. The data formatting element 406 may thus include instructions for converting disparate data types into the single format used by the clinical analysis module 402. In some embodiments, the data formatting element 406 may further perform initial analysis on the record data 404 to extract particular characteristics, determine or extract record metadata, or the like. For example, in embodiments where the record data includes a medical imaging study, the data formatting element 406 may extract text annotations applied to the medical imaging study and store those text annotations as strings in the formatted data 408.

The formatted data 408 may be stored by the data formatting element 406 and provided to a derivation element 410. The derivation element 410 may perform additional analysis on the formatted data 408 based on a set of derivation rules 412. The derivation rules may include a set of conditional statements and natural language parsing/extraction instructions for analyzing received data and deriving additional conclusions for display within the visualization interface. For example, the derivation rules may include instructions that apply conditionals that utilize data fields associated with different record sources (e.g., using a first data field associated with a medical imaging study and a second data field associated with patient demographic data obtained from an electronic health records datastore).

An example set of conditional rules for determining whether a risk of coronary disease is present may be implemented as follows:

TABLE 1
1) Name = Mild Coronary Heart Risk
Description = Mild Risk Of Coronary Heart Disease
Expression = (30 <= age < 50) AND (smoker == “YES”) AND (Heart
Condition CONTAINS “irregular”)
2) Name = Severe Coronary Heart Risk
Description = Severe Risk Of Coronary Heart Disease
Expression = (50 <= age < 75) AND (smoker == “YES”) AND (Heart
Condition CONTAINS “irregular”)
3) Name = Coronary Heart Problems
Description = Coronary Heart Problems
Expression = (75 <= age) AND (smoker == “YES”)
4) Name = Healthy Heart
Description = No Heart Ailments
Expression = (NOT “Mild Coronary Heart Risk”) AND (NOT “Severe
Coronary Heart Risk”) AND (NOT “Coronary Heart Problems”)

As presented above the term “Heart Condition” is a derived attribute from Natural Language Processing of the “History” data. The 4th conditional expression uses the previous 3 conditional expressions themselves as criteria.

The derivation rules may specify a variety of criteria and other conditionals for identifying certain derived data values. Some derivation rules may define certain risk factors or diagnoses based on patient symptoms, demographic data, height, weight, age, and the like. For example, if a patient is a smoker and has a weight over a certain value, then the derivation rules may indicate the patient has an elevated risk for heart disease.

Other derivation rules may identify particular tokens, strings, or the like for parsing patient electronic health records using natural language processing. For example, if the term “irregular” is present within a field associated with a patient's heart, then the condition “irregular heart beat” may be added as a derived data value.

The derivation element 410 applies the derivation rules 412 to the formatted data 408 to generate a set of derived data 414. The derived data 414 and the formatted data 408 are provided to a visualization element 416 to generate a visualization interface 418. The visualization interface 418 includes a set of interface controls that are populated based on the received derived data 414 and formatted data 408. The visualization interface 418 may be updated as new data is received or the derived data 414 and/or formatted data 408 are changed. For example, the visualization element 416 may periodically poll for new or updated data and update the visualization interface 418 accordingly, or a callback system may notify the visualization interface 418 when a change to either the formatted data 408 or the derived data 414 has occurred.

### Exemplary Processes for Implementing a Visualization Interface

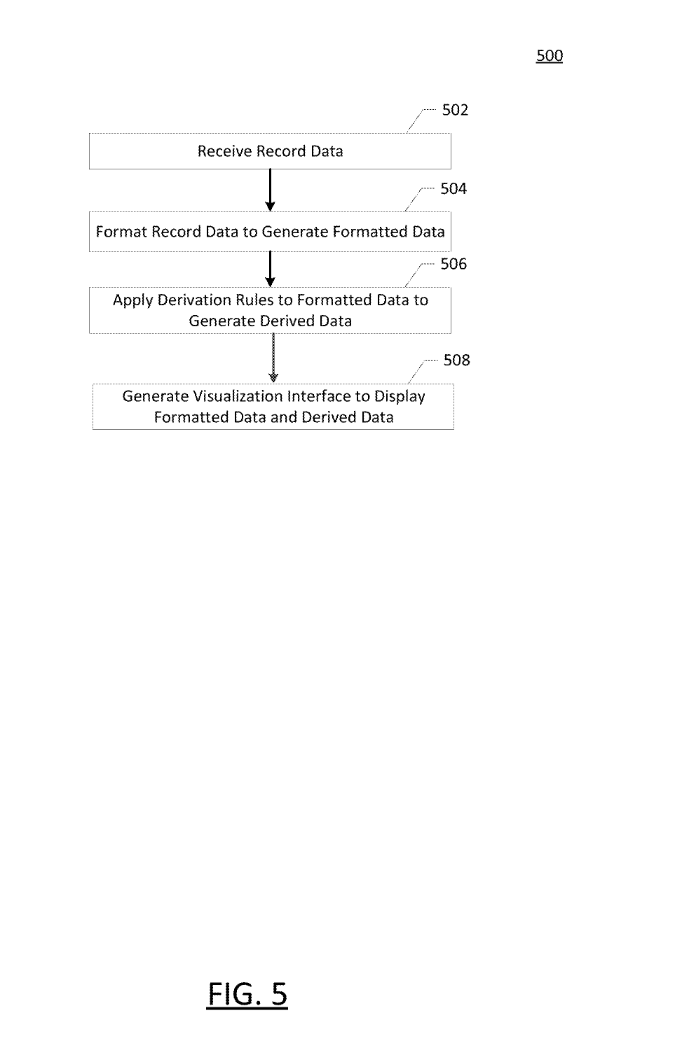

FIG. 5 is a flow diagram depicting an exemplary process 500 for implementing an improved visualization interface in accordance with embodiments of the present invention. These processes may be employed by an apparatus, such as the apparatus 100 described above, to perform tasks related to receiving a set of clinical data, formatting the data, processing the data to identify derived data, and using the formatted data and derived data to generate a visualization interface. In this regard, these processes describe algorithms that are implemented via hardware or software executing on hardware components of an apparatus to implement these tasks and other tasks related to improved visualization interfaces. These algorithms may serve as means for implementing these tasks and other functions as described above and herein.

At action 502, a set of clinical data is received. As noted above, the received data may include electronic health records, answers to patient questionnaires, medical study images, data manually entered via a field of a visualization interface, or any other mechanism for receiving input values for data with clinical significance. At action 504, the clinical data is formatted to generate a set of formatted data. As described above, formatting the data may include converting the data into a source-agnostic format, such as JSON. However, although a common format may be employed, different types of received data may still have different data fields even after formatted. For example, a first set of data may include patient demographic data and have fields for patient age and ethnicity, while a second set of data may include a medical image study and have fields for text annotations applied to the image. In some embodiments, multiple sets of data may be combined to generate a single set of formatted data associated with a particular patient, group of patients, set of studies, or the like.

At action 506, a set of derivation rules are applied to the formatted data to generate a set of derived data. As described above, derived data may be generated using a set of rules or conditions that specify criteria for certain findings (e.g., possible diagnoses based on the presence of symptoms, disease risks based on the presence of a minimum number of risk factors, or the like). The derived data may be stored in addition to the formatted data or as a further component of the formatted data (e.g., by adding fields to or updating fields of the formatted data).

At action 508, the derived data and the formatted data are used to generate a visualization interface. As described above with respect to FIGS. 2A-4, the visualization interface may present the derived data and the formatted data in a logical manner such that different types of data are separated and/or segregated into different interface controls. It should further be appreciated that the interface may include certain controls for showing and hiding certain types of data. For example, a given clinician may wish to show or hide data related to a certain condition or illness, and selection of an interface control associated with a diagnosis of that condition or illness may highlight or otherwise display data fields that have an association with that condition or illness. The interface may also allow for showing or hiding data related to a particular encounter, a specific study, a specific data store (e.g., display only data received from electronic health record systems), or the like.

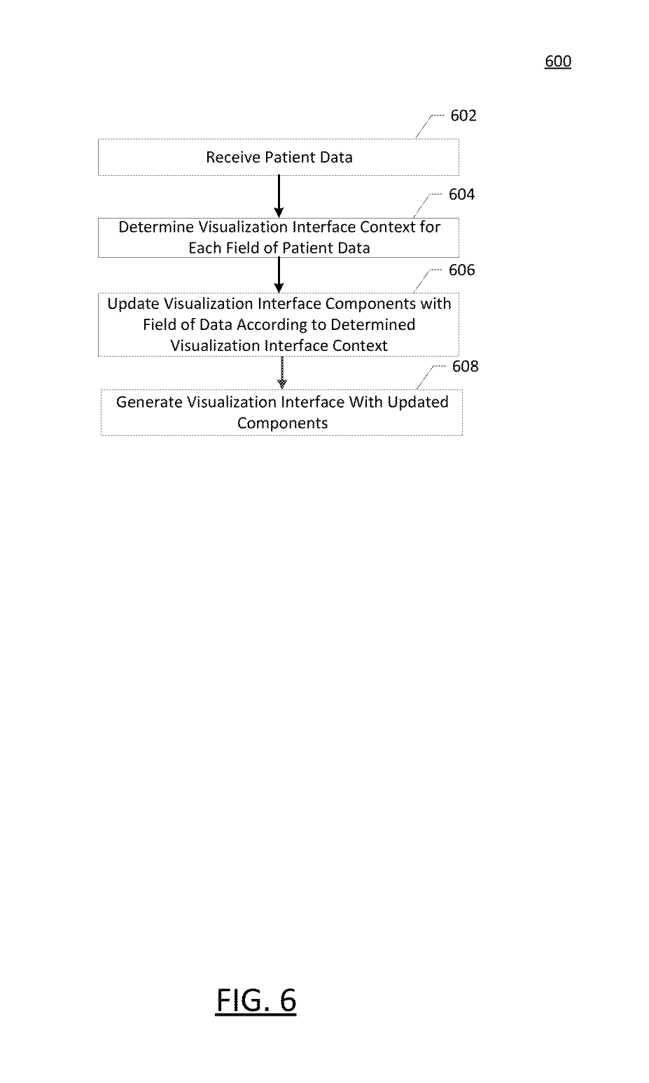

FIG. 6 illustrates an example of a flow diagram of a process 600 for generating a visualization interface in accordance with embodiments of the present invention. The process 600 illustrates how the individual interface controls of the visualization interface are populated with relevant data from the set of received data. To this end, the process 600 is operable to review and parse data received as part of a formatting and derivation process as described above with respect to FIGS. 2-5. This formatted and derived data may include a variety of data fields which relate to different clinically significant values, such as patient symptoms, patient demographic data, patient vital signs, data derived from natural language processing of patient records, likely diagnoses, and the like. The process 600 functions to intelligently apportion these disparate data types into different associated interface controls, ensuring that the visualization interface is flexible and efficient in its display of relevant patient data. The process 600 may be performed by an apparatus, such as the apparatus 100 described above with respect to FIG. 1.

At action 602, patient data is received. As described above with respect to FIG. 5, the patient data may include both formatted and derived data. At action 604, an appropriate context is determined for one or more fields of the received data. It should be appreciated that different fields may have different contexts within the visualization interface at different times. For example, in some scenarios all patient data may be displayed in corresponding interface controls (e.g., demographic data in a demographic interface control), with no filtering or constraints on the displayed data. In other scenarios, the data that is displayed may be filtered, such as where a user selects a particular condition from an anatomical approximation displayed in the interface, and indicates they only wish to view data relevant to that particular condition. In yet further scenarios, the context of the data may change based upon the presence of other data or contexts. For example, an additional interface control may be added to aggregate all information related to risk factors for a heart condition if the patient displays more than a threshold number of risk factors for the heart condition. Such a control may aggregate symptom data, demographic data, and other risk factors rather than apportioning those data fields to separate interface controls.

At action 606, one or more of the interface controls are updated according to the determined context. As indicated above, updating these interface controls may include creating or deleting interface controls, or modifying the data presented within those controls. This process may include interacting with various interface frameworks and components for providing windows, menus, and the like and providing data to update those frameworks and components. It should be appreciated that such interface interactions may be performed according to known operating system constructs or other basic functioning of computer graphical user interfaces.

At action 608, the visualization interface is generated according to the updated interface controls. Generation of the visualization interface may include outputting the interface to one or more displays or otherwise transmitting or broadcasting the generated display in order to provide an efficient, flexible mechanism for viewing patient data.

It will be understood that each element of the flowcharts, and combinations of elements in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 104 of an apparatus employing an embodiment of the present invention and executed by a processor 102 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method for implementing a computer visualization interface, the method comprising:
receiving a first set of clinical data associated with one or more patients;
formatting the first set of clinical data for inclusion in a data object;
processing the data object to generate a set of derived data;
generating a visualization interface comprising at least one component of the formatted data and the derived data; and
causing output of the visualization interface.

2. The method of claim 1, wherein the visualization interface further comprises a first interface control, the first interface control comprising an anatomical approximation of a human body and one or more sub-interface controls associated with one or more clinical statuses derived from the first set of clinical data, such that selection of the one or more sub-interface controls displays additional information related to the one or more clinical statuses.

3. The method of claim 2, wherein the visualization interface further comprises a second interface control for displaying demographic data derived from the first set of clinical data, wherein selection of the sub-interface control causes an interface effect to be applied to at least one element of the demographic data associated with the one or more clinical statuses associated with the sub-interface control.

4. The method of claim 1, further comprising:
receiving a second set of clinical data associated with the one or more patients;
formatting the second set of clinical data for inclusion in the data object; and
adding the formatted second set of clinical data to the data object.

5. The method of claim 1, further comprising:
receiving a second set of clinical data associated with the one or more patients;
updating the visualization interface to comprise at least one of a component of the second set of clinical data or data derived from the second set of clinical data; and
applying a first interface effect to a first element of the visualization interface derived from the first set of clinical data, and a second interface effect to a second element of the visualization interface derived from the second set of clinical data, wherein the first interface effect is different from the second interface effect and wherein the first interface effect is selected based on the first element being associated with the first set of clinical data and the second element being associated with the second set of clinical data.

6. The method of claim 1, further comprising receiving, at the visualization interface via a drag and drop operation, at least one clinical data record dragged from an electronic health record interface, wherein the drag and drop operation causes the at least one clinical data record to be provided as the first set of clinical data.

7. The method of claim 1, wherein processing the data object to generate the derived data comprises applying a set of derivation rules, the set of derivation rules comprising one or more conditional statements to be applied to the clinical data to generate the derived data.

8. The method of claim 1, wherein the visualization interface further comprises a data entry control, and wherein the method further comprises:
receiving entered clinical data via the data entry control;
updating at least one of the formatted data or the derived data to reflect the entered clinical data; and
updating the visualization interface to reflect the updated at least one of the formatted data or the derived data.

9. An apparatus for implementing a computer visualization interface, the apparatus comprising a processor and a memory, the memory storing instructions executed by the processor to configure the processor to:
receive a first set of clinical data associated with one or more patients;
format the first set of clinical data for inclusion in a data object;
process the data object to generate a set of derived data;
generate a visualization interface comprising at least one component of the formatted data and the derived data; and
cause output of the visualization interface.

10. The apparatus of claim 9, wherein the visualization interface further comprises a first interface control, the first interface control comprising an anatomical approximation of a human body and one or more sub-interface controls associated with one or more clinical statuses derived from the first set of clinical data, such that selection of the one or more sub-interface controls displays additional information related to the one or more clinical statuses.

11. The apparatus of claim 10, wherein the visualization interface further comprises a second interface control for displaying demographic data derived from the first set of clinical data, wherein selection of the sub-interface control causes an interface effect to be applied to at least one element of the demographic data associated with the one or more clinical statuses associated with the sub-interface control.

12. The apparatus of claim 19 further configured to:
receive a second set of clinical data associated with the one or more patients;
format the second set of clinical data for inclusion in the data object; and
add the formatted second set of clinical data to the data object.

13. The apparatus of claim 9, further configured to:
receive a second set of clinical data associated with the one or more patients;
update the visualization interface to comprise at least one of a component of the second set of clinical data or data derived from the second set of clinical data; and
apply a first interface effect to a first element of the visualization interface derived from the first set of clinical data, and a second interface effect to a second element of the visualization interface derived from the second set of clinical data, wherein the first interface effect is different from the second interface effect and wherein the first interface effect is selected based on the first element being associated with the first set of clinical data and the second element being associated with the second set of clinical data.

14. The apparatus of claim 9, further configured to receive, at the visualization interface via a drag and drop operation, at least one clinical data record dragged from an electronic health record interface, wherein the drag and drop operation causes the at least one clinical data record to be provided as the first set of clinical data.

15. The apparatus of claim 9, wherein processing the data object to generate the derived data comprises applying a set of derivation rules, the set of derivation rules comprising one or more conditional statements to be applied to the clinical data to generate the derived data.

16. The apparatus of claim 9, wherein the visualization interface further comprises a data entry control, and wherein the apparatus is further configured to:
receive entered clinical data via the data entry control;
update at least one of the formatted data or the derived data to reflect the entered clinical data; and
update the visualization interface to reflect the updated at least one of the formatted data or the derived data.

17. A non-transitory computer readable storage medium comprising instructions that, when executed by the processor, cause the processor to at least:
receive a first set of clinical data associated with one or more patients;
format the first set of clinical data for inclusion in a data object;
process the data object to generate a set of derived data;
generate a visualization interface comprising at least one component of the formatted data and the derived data; and
cause output of the visualization interface.

18. The computer readable storage medium of claim 17, wherein the visualization interface further comprises a first interface control, the first interface control comprising an anatomical approximation of a human body and one or more sub-interface controls associated with one or more clinical statuses derived from the first set of clinical data, such that selection of the one or more sub-interface controls displays additional information related to the one or more clinical statuses.

19. The computer readable storage medium of claim 18, wherein the visualization interface further comprises a second interface control for displaying demographic data derived from the first set of clinical data, wherein selection of the sub-interface control causes an interface effect to be applied to at least one element of the demographic data associated with the one or more clinical statuses associated with the sub-interface control.

20. The computer readable storage medium of claim 17, wherein the visualization interface further comprises a data entry control, and wherein the instructions further configure the processor to:
receive entered clinical data via the data entry control;
update at least one of the formatted data or the derived data to reflect the entered clinical data; and
update the visualization interface to reflect the updated at least one of the formatted data or the derived data.
